(19) United States
(12) Patent Application Publication
(10) Pub. No.: US 2012/0269345 A1
(43) Pub. Date: Oct. 25, 2012

(54) INTEGRATED CIRCUIT (IC) CARD

(76) Inventors: Masakazu Ukita, Kanagawa (JP); Yohei Kawamoto, Tokyo (JP); Yu Tanaka, Tokyo (JP)

(21) Appl. No.: 13/445,401

(22) Filed: Apr. 12, 2012

(30) Foreign Application Priority Data
Apr. 19, 2011 (JP) 2011-092577

(51) Int. Cl. H04K 1/00

(52) U.S. Cl. 380/256

(57) ABSTRACT

There is provided an integrated circuit (IC) card including a modulating unit that modulates an optical pulse and outputs the modulated optical pulse to a quantum communication path, a communication unit that performs classical communication via a classical communication path, and a control unit that changes a modulation state of the optical pulse, performs quantum communication, and generates a common key based on the classical communication of information according to a communication result of the quantum communication.

### BACKGROUND

The present technology relates to an IC card. More specifically, an IC card is provided with a quantum cryptography communication function, and thus a shared secret key can be safely generated.

In the past, security in communications performed via the Internet or the like has been protected by cryptographic techniques. A cryptosystem is roughly divided into two systems of a common key cryptosystem and a public key cryptosystem. For example, advanced encryption standard (AES) or the like is currently in common use for the common key cryptosystem, and RSA or the like is currently in common use for the public key cryptosystem.

In the common key cryptosystem, both parties that perform communication hold a common secret key. A transmitting party encrypts a plain text using a secret key and creates a cipher text, and a receiving party decrypts the cipher text using the same secret key and obtains the original plain text.

In the common key cryptosystem, keeping secret of a key is the key to security protection. In the common key cryptosystem, when a so-called “brute-force attack” that searches a key by a brute force is performed, a key is made known at a high probability. Of course, in the currently used common key cryptosystem, it is estimated that unrealistically many resources (performance of a calculator or the number of calculators) are necessary in order to perform the brute-force attack. Thus, it seems that it is safe at this point in time. However, in the future, the brute-force attack is expected to be realistic by improvement in performance of a calculator or the like. Actually, a system called a 2-key triple data encryption standard (TDES) which has been used from the past has been encouraged to transition to AES.

Security against attacks including the brute-force attack can be enhanced by using a method of frequently updating a common key. That is, even if an attacker eavesdrops on communication and gains a key, when the key is frequently updated, an amount of cipher texts which can be decrypted using the key is small, and thus overall information obtained by the attacker is relatively small.

As one of methods of frequently updating a common key, a method of performing quantum key distribution (QKD) using quantum cryptography communication was proposed in Japanese Patent No. 4015385. The quantum key distribution is a protocol for generating a common secret key between two parties which are connected by a communication path capable of transmitting a quantum state and a normal communication path. This protocol is based on the principle of quantum mechanics. Even if an attacker eavesdrops on a communication path, information of a generated secret key does not leak to the attacker. Using the quantum key distribution protocol, a secret key can be shared between two parties away from each other. Thus, by generating a key as necessary using the quantum key distribution protocol, the common key can be frequently updated as described above. In this way, by combining the common key cryptosystem with the quantum key distribution, security of the common key cryptosystem can be enhanced.

In the quantum key distribution, for example, a 6-state protocol extended from BB84 protocol or B84 protocol is being used. Further, as described in Japanese Patent Application Laid-Open No. 2007-286551, a decoy technique capable of further enhancing encryption intensity of the quantum key distribution by performing intensity modulation of an optical pulse is also used.

For these techniques, refer to, for example, Japanese Patent No. 4015385 and Japanese Patent Application Laid-Open No. 2007-286551.

### SUMMARY

Meanwhile, integrated circuit (IC) cards in which an IC capable of recording information or performing a calculation for various purposes such as a means of payment, an individual identification means, and the like is embedded are widely being used. In a system using an IC card, an encryption key is used for mutual authentication or encrypted communication, and high security of an encryption key is necessary.

Further, in the quantum key distribution of related art, a large-scale, complicated, high-price communication device has to be installed at both parties which desire to generate a common key so as to distribute a quantum key. Further, in the quantum key distribution, for example, it is necessary to connect two parties, which desire to generate a common key, to each other by an optical fiber in which a relay or amplification is not performed in midstream or a quantum communication path using optical transmission in unobstructed space. Thus, it is difficult for an individual to safely generate a common key using the quantum key distribution and to use it.

In light of the foregoing, it is desirable to provide an IC card capable of simply and safely generating a common key at a low cost using the quantum key distribution.

According to an embodiment of the present technology, there is provided an IC card which includes a modulating unit that modulates an optical pulse and outputs the modulated optical pulse to a quantum communication path, a communication unit that performs classical communication via a classical communication path, and a control unit that changes a modulation state of the optical pulse, performs quantum communication, and generates a common key based on the classical communication of information according to a communication result of the quantum communication.

In the present technology, the modulation state of the optical pulse in the modulating unit is controlled by the control unit and randomly changed, for example, to any one of a plurality of previously set modulation states, and the quantum communication is performed. Further, the control unit generates a common key based on the classical communication of information according to a communication result of the quantum communication. The modulating unit modulates an optical pulse input from a terminal device to one surface of a card and outputs a modulated optical pulse from the other surface. Alternatively, a reflecting unit that reflects the optical pulse is provided. The reflecting unit reflects an optical pulse output from the modulating unit to return to the modulating unit, and the modulating unit modulates an optical pulse input from one surface of a card and outputs a modulated optical pulse from the one surface. Alternatively, the optical pulse is input from a card end portion to the modulating unit via a first waveguide, and an optical pulse modulated by the modulating unit is output from the card end portion via a second waveguide. Alternatively, an optical path converting unit that bends an optical path of an optical pulse input from one surface of a card and causes the optical pulse to be output from a card end portion via a waveguide is provided, and the modulating unit is arranged in the middle of the optical path of the optical pulse.

When the IC card is provided with a light source unit that generates an optical pulse, an optical pulse supplied from the light source unit via a first waveguide is modulated by the modulating unit and output from a card end portion via a second waveguide. Alternatively, an optical path converting unit bends an optical path of an optical pulse supplied from the light source unit via a waveguide formed in a card surface direction and causes the optical pulse to be output from one surface of a card, and the modulating unit is arranged in the middle of the optical path of the optical pulse and modulates the optical pulse. Alternatively, the light source unit and the modulating unit are stacked, and the optical pulse generated by the light source unit is modulated by the modulating unit and then output from one surface of a card. Further, the modulating unit performs, for example, polarization modulation or phase modulation of the optical pulse.

According to the embodiments of the present technology described above, an IC card is provided with a modulating unit that modulates an optical pulse and outputs a modulated optical pulse and a control unit that randomly changes a modulation state of an optical pulse to any one of a plurality of previously set modulation states. The IC card can perform quantum cryptography communication with a terminal device. Thus, a common key can be simply and safely generated at a low cost through quantum cryptography communication.

### BRIEF DESCRIPTION OF THE DRAWINGS

FIG. 1 illustrates an example of an overall configuration of a system using an IC card;

FIG. 2 is a diagram illustrating an overall configuration according to a first embodiment;

FIG. 3A is a diagram illustrating a first structure example of an IC card according to the first embodiment;

FIG. 3B is a diagram illustrating the first structure example of the IC card according to the first embodiment;

FIG. 4 is a diagram illustrating a first structure example of a terminal device according to the first embodiment;

FIG. 5 is a diagram illustrating a block configuration of an optical system for performing quantum cryptography communication;

FIG. 6 is a diagram for describing polarization modulation;

FIG. 7A is a diagram illustrating a second structure example of the IC card according to the first embodiment;

FIG. 7B is a diagram illustrating the second structure example of the IC card according to the first embodiment;

FIG. 8 is a diagram illustrating a second structure example of the terminal device according to the first embodiment;

FIG. 9A is a diagram illustrating a third structure example of the IC card according to the first embodiment;

FIG. 9B is a diagram illustrating the third structure example of the IC card according to the first embodiment;

FIG. 10 is a diagram illustrating a third structure example of the terminal device according to the first embodiment;

FIG. 11 is a diagram illustrating a third structure example of the terminal device when a phase modulator is used;

FIG. 12 is a diagram illustrating a configuration of a modulation analyzing unit when phase modulation is used;

FIG. 13A is a diagram illustrating a fourth structure example of the IC card according to the first embodiment;

FIG. 13B is a diagram illustrating the fourth structure example of the IC card according to the first embodiment;

FIG. 14 is a diagram illustrating a fourth structure example of the terminal device according to the first embodiment;

FIG. 15 is a diagram illustrating a fourth structure example of the terminal device when a phase modulator is used;

FIG. 16 is a diagram illustrating an overall configuration according to a second embodiment;

FIG. 17A is a diagram illustrating a first structure example of an IC card according to the second embodiment;

FIG. 17B is a diagram illustrating the first structure example of the IC card according to the second embodiment;

FIG. 18 is a diagram illustrating a first structure example of a terminal device according to the second embodiment;

FIG. 19A is a diagram illustrating a second structure example of the IC card according to the second embodiment;

FIG. 19B is a diagram illustrating the second structure example of the IC card according to the second embodiment;

FIG. 20 is a diagram illustrating a second structure example of the terminal device according to the second embodiment;

FIG. 21A is a diagram illustrating a third structure example of the IC card according to the second embodiment; and

FIG. 21B is a diagram illustrating the third structure example of the IC card according to the second embodiment.

### DETAILED DESCRIPTION OF THE EMBODIMENTS

Hereinafter, preferred embodiments of the present technology will be described in detail with reference to the appended drawings. Note that, in this specification and the appended drawings, structural elements that have substantially the same function and structure are denoted with the same reference numerals, and repeated explanation of these structural elements is omitted.

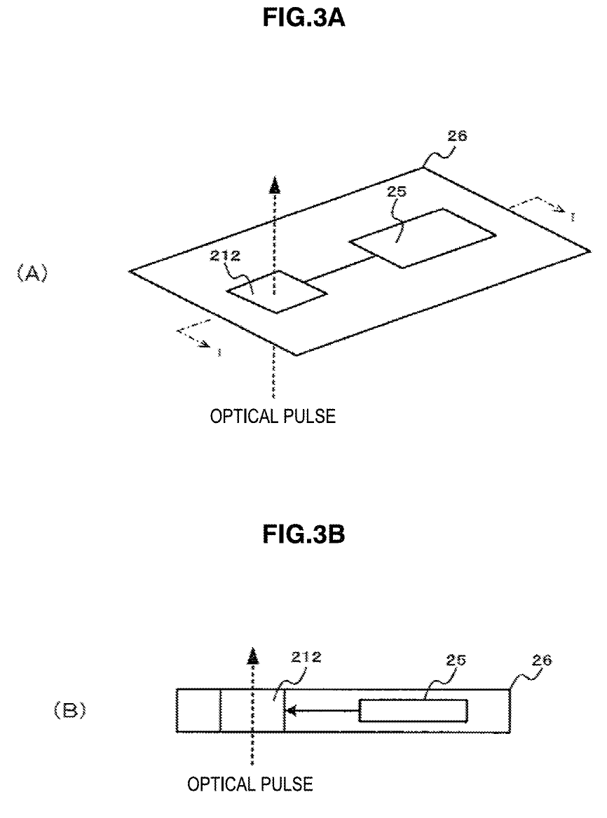

Hereinafter, embodiments of the present technology will be described. In this disclosure, FIG. 3A, FIG. 3B, or the like may be described as FIG. 3(A), FIG. 3(B), or the like. Further, a description will be made in the following order:

1. Overall Configuration of System Using IC Card

2. Overall Configuration According to First Embodiment
2-1. First Structure Example of IC Card and Terminal Device According to First Embodiment
2-2. Communication Operation Between IC Card and Terminal Device
2-3. Second Structure Example of IC Card and Terminal Device According to First Embodiment
2-4. Third Structure Example of IC Card and Terminal Device According to First Embodiment
2-5. Fourth Structure Example of IC Card and Terminal Device According to First Embodiment

3. Overall Configuration According to Second Embodiment
3-1. First Structure Example of IC Card and Terminal Device According to Second Embodiment
3-2. Second Structure Example of IC Card and Terminal Device According to Second Embodiment
3-3. Third Structure Example of IC Card and Terminal Device According to Second Embodiment

### 1. Overall Configuration of System Using IC Card

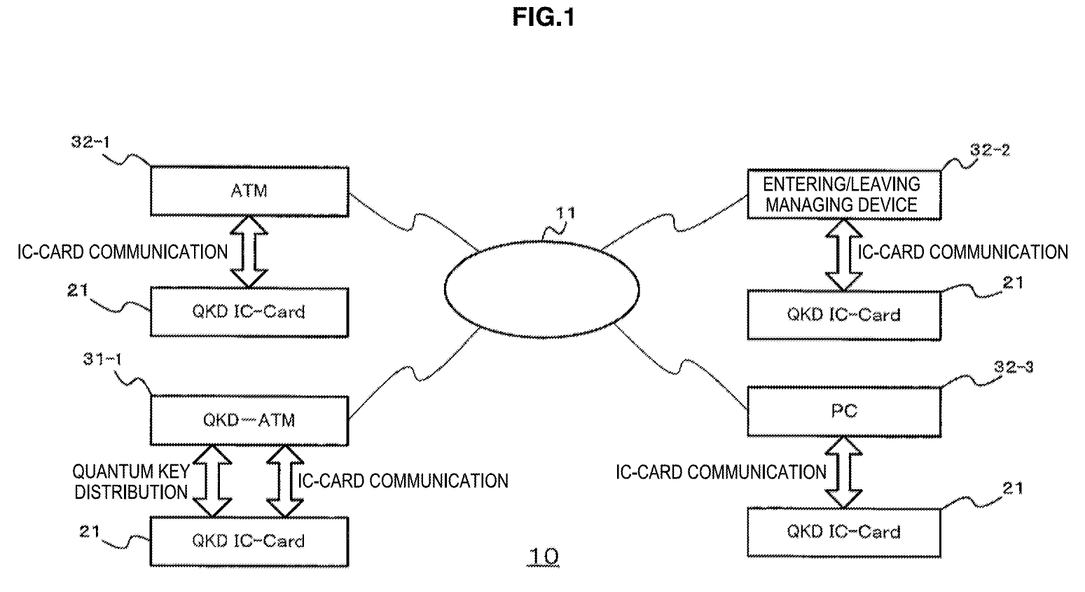

FIG. 1 illustrates an example of an overall configuration of a system 10 using an IC card. A terminal device that performs communication with an IC card is connected to a center 11 via a network. As the terminal device, used is a terminal device 31, which is provided with a quantum cryptography communication function and can perform quantum cryptography communication with an IC card (QKD IC-Card) 21, such as an ATM (QKD-ATM) 31-1 provided with the quantum cryptography communication function. Further, as the terminal device, there may be used a terminal device 32, which is not provided with the quantum cryptography communication function, such as an ATM 32-1 of related art, an entering/leaving managing device 32-2 for performing entering/leaving management using an IC card, and a computer (PC) 32-3 with a terminal function of an IC card.

The IC card 21 and the terminal device 31 which have the quantum cryptography communication function generate a common key by performing the quantum key distribution through the quantum cryptography communication. The common key cryptosystem communication is performed between the IC card and the terminal device using the generated common key. As the common key cryptosystem, a stream cipher, a Vernam cipher, and the like as well as a block cipher such as AES are used. The generated common key is supplied from the center 11 to the terminal device 32 which is not provided with the quantum cryptography communication function, and then common key cryptosystem communication, authentication using the common key, or the like is performed in the terminal device 32. The IC card 21 performs communication with the terminal device in a non-contact state or a contact state.

When the quantum cryptography communication is performed, the IC card 21 modulates an optical pulse output from a light source unit arranged in the terminal device 31 or an optical pulse output from a light source unit arranged in the IC card 21, and then performs the quantum cryptography communication. For modulation of an optical pulse, for example, polarization modulation or phase modulation is performed. In the following, a first embodiment will be described in connection with an example in which an IC card modulates an optical pulse output from a light source unit arranged in a terminal device with the quantum cryptography communication function and then performs quantum cryptography communication. Further, a second embodiment will be described in connection with an example in which an IC card modulates an optical pulse output from a light source unit arranged in an IC card and then performs quantum cryptography communication.

### 2. Overall Configuration According to First Embodiment

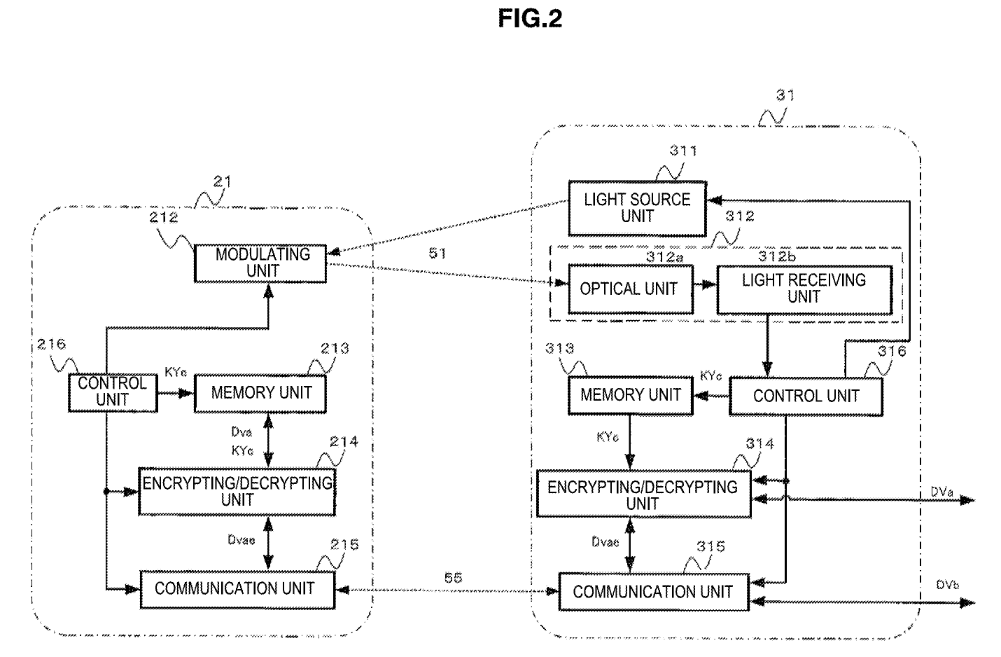

FIG. 2 is a diagram illustrating an overall configuration according to the first embodiment. The IC card 21 is connected with the terminal device 31 via a quantum communication path 51 and a classical communication path 55.

The IC card 21 includes a modulating unit 212, a memory unit 213, an encrypting/decrypting unit 214, a communication unit 215, and a control unit 216.

The modulating unit 212 changes, for example, a polarization state of an optical pulse output from the terminal device 31 to any one of a plurality of previously set polarization bases. The modulating unit 212 is configured with a variable wave plate such as a liquid crystal retarder. The modulating unit 212 performs polarization modulation based on a control signal from the control unit 216, changes a polarization state of an optical pulse emitted from the terminal device 31 to any one of a plurality of polarization bases previously set based on a control signal at a high speed, and supplies the terminal device 31 with the polarization base via the quantum communication path 51.

The memory unit 213 stores a common key KYc generated by the control unit 216 or various pieces of information. The encrypting/decrypting unit 214 encrypts/decrypts information DVa/encrypted information DVae stored in the memory unit 213 using the common key KYc stored in the memory unit 213.

The communication unit 215 transmits information DVb that does not use a cipher or the information DVae encrypted by the encrypting/decrypting unit 214 to the terminal device 31 via the classical communication path 55. Further, the communication unit 215 receives information transmitted from the terminal device 31 via the classical communication path 55. When the received information is non-encrypted information, the communication unit 215 stores the received information, for example, in the memory unit 213. However, when the received information is encrypted information, the communication unit 215 supplies the received information DVae to the encrypting/decrypting unit 214. Thus, the decrypted information DVa is supplied from the encrypting/decrypting unit 214 to the memory unit 213 and then stored in the memory unit 213.

The control unit 216 performs control of a modulation process which the modulating unit 212 performs on an optical pulse output from the terminal device 31 so as to perform the quantum cryptography communication. Further, the control unit 216 performs communication with the terminal device 31 via the communication unit 215 or the classical communication path 55. Furthermore, the control unit 216 performs a process of generating a common key based on a communication result of the quantum cryptography communication, communication control of information, control of encryption or decryption using a common key, and the like.

The terminal device 31 includes a light source unit 311, a modulation analyzing unit 312, a memory unit 313, an encrypting/decrypting unit 314, a communication unit 315, and a control unit 316.

The light source unit 311 is configured with a semiconductor light-emitting device such as a laser diode or an LED. The light source unit 311 outputs an optical pulse output from the semiconductor light-emitting device to the IC card 21. Further, the light source unit 311 performs output control of an optical pulse through the control unit 316. The light source unit 311 may be provided with a lens for collimating an optical pulse emitted from the semiconductor light-emitting device.

The modulation analyzing unit 312 includes an optical unit 312a and a light receiving unit 312b. The optical unit 312a sorts an optical pulse, which has been subjected to polarization modulation, supplied from the IC card 21 via the quantum communication path 51 according to each polarization base. The light receiving unit 312b detects the optical pulse which is sorted according to each polarization base for each polarization base, and outputs the detection result to the control unit 316.

The memory unit 313 stores the common key KYc which the control unit 316 has generated based on the detection result from the light receiving unit 312b. Further, the encrypting/decrypting unit 314 encrypts the information DVa using a cipher or decrypts the encrypted information DVae using the common key KYc stored in the memory unit 313.

The communication unit 315 transmits the information DVb that does not use a cipher or the information DVae encrypted by the encrypting/decrypting unit 314 to the IC card 21 via the classical communication path 55. Further, the communication unit 315 receives information transmitted from the IC card 21 via the classical communication path 55. When the received information is non-encrypted information, the communication unit 315 supplies the received information DVb to a signal processing unit (not shown). However, when the received information is encrypted information, the communication unit 315 supplies the received information DVae to the encrypting/decrypting unit 314. Thus, the decrypted information DVa is supplied from the encrypting/decrypting unit 314 to the signal processing unit.

The control unit 316 performs output control of an optical pulse on the light source unit 311. Further, the control unit 316 performs communication with the IC card 21 via the communication unit 315 or the classical communication path 55 using the detection result of the light receiving unit 312b. Furthermore, the control unit 316 performs a process of generating a common key based on a communication result of the quantum cryptography communication, communication control of information, control of encryption or decryption using a common key, and the like.

### 2-1. First Structure Example of IC Card and Terminal Device According to First Embodiment

FIGS. 3A and 3B illustrate a first structure example of an IC card according to the first embodiment. FIG. 3A is a perspective view of an IC card, and FIG. 3B is a schematic cross-sectional view taken along line I-I in the IC card of FIG. 3A. The IC card 21 is configured such that a substrate 25 provided with the memory unit 213, the encrypting/decrypting unit 214, the communication unit 215, and the control unit 216 illustrated in FIG. 2 is interposed between outer sheets 26. A through hole is formed in the outer sheet 26, and the modulating unit 212 such as a liquid crystal retarder is mounted to the through hole. The modulating unit 212 modulates an optical pulse input from one surface of the IC card 21 and outputs a modulated optical pulse from the other surface.

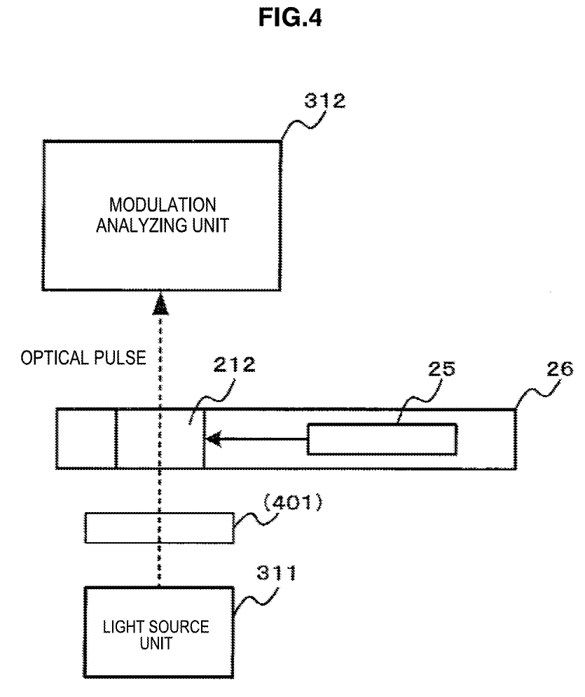

FIG. 4 illustrates a first structure example of the terminal device according to the first embodiment. In the terminal device 31, the light source unit 311 is arranged to face the modulation analyzing unit 312. An optical pulse output from the light source unit 311 is input to the modulation analyzing unit 312. Further, when the terminal device 31 performs quantum cryptography communication with the IC card 21, the IC card 21 is arranged at the position capable of modulating the optical pulse output from the light source unit 311 through the modulating unit 212. A polarizer 401 may be arranged at an optical pulse input surface side of the modulating unit 212. In this case, even though the position of the modulating unit 212 relative to the light source unit 311 is not precisely controlled, a polarization direction and an optical axis of the modulating unit 212 can be set at a desired angle, which will be described later. When the polarizer 401 is arranged in the terminal device 31, a configuration of the IC card 21 can be simplified.

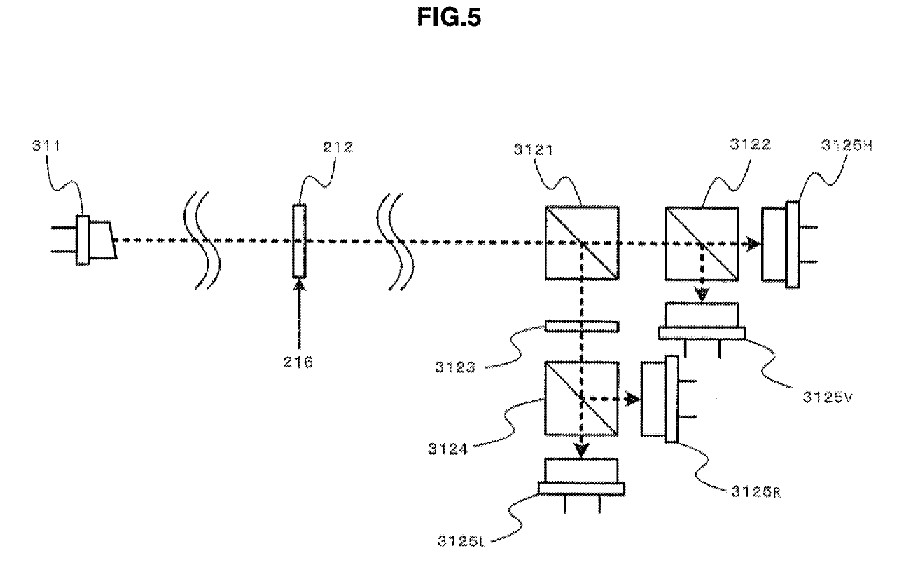

FIG. 5 illustrates a block configuration of an optical system for performing the quantum cryptography communication. Further, FIG. 5 illustrates an example in which polarization modulation is performed. The optical pulse output from the light source unit 311 is modulated by the modulating unit 212. The modulating unit 212 employs a liquid crystal retarder that converts a polarization state of an optical pulse to any one of four types of polarization states. The liquid crystal retarder is arranged such that its optical axis is inclined at 45° with respect to a linear polarization direction of an optical pulse output from the light source unit 311. The liquid crystal retarder changes a phase difference between a polarization component parallel to a FAST axis and a polarization component parallel to a SLOW axis thereof, in response to the control signal from the control unit 216.

Further, in the modulating unit 212, when the optical pulse output from the light source unit 311 is not linearly polarized light or when the optical pulse is linearly polarized light but it is difficult to precisely control the polarization direction relative to the optical axis of the liquid crystal retarder, a polarizer is arranged at an optical pulse input surface side of the liquid crystal retarder. For example, the polarizer is arranged at the optical pulse input surface side of the liquid crystal retarder, and the polarizer is integrated with the liquid crystal retarder such that the optical axis of the liquid crystal retarder is set to be inclined at 45° with respect to an optical pulse of linearly polarized light having passed through the polarizer. When the modulating unit 212 is configured in the above-described manner, even though the position of the modulating unit 212 relative to the light source unit 311 is not precisely controlled, the polarization direction and the optical axis of the liquid crystal retarder can be set at a desired angle.

The optical unit 312a of the modulation analyzing unit 312 illustrated in FIG. 2 includes a non-polarizing beam splitter 3121, polarizing beam splitters 3122 and 3124, and a ¼ wave plate 3123 as illustrated in FIG. 5. Further, the light receiving unit 312b includes light receiving elements 3125H, 3125V, 3125R, and 3125L.

The non-polarizing beam splitter 3121 splits the optical pulse from the IC card 21 without changing the polarization state of the optical pulse. The polarizing beam splitter 3122 polarization-splits one component of the optical pulse split by the non-polarizing beam splitter 3121. The ¼ wave plate 3123 converts the polarization state of the other component of the optical pulse split by the non-polarizing beam splitter 3121 to a circularly polarized light when the optical pulse is linearly polarized light or to linearly polarized light when the optical pulse is circularly polarized light. The polarizing beam splitter 3124 polarization-splits the optical pulse whose polarization state has been changed by the ¼ wave plate 3123.

The light receiving unit 312b includes the light receiving elements 3125H, 3125V, 3125R, and 3125L. The light receiving element 3125H detects one component of the optical pulse polarization-split by the polarizing beam splitter 3122, and the light receiving element 3125V detects the other component of the optical pulse polarization-split by the polarizing beam splitter 3122. Similarly, the light receiving element 3125R detects one component of the optical pulse polarization-split by the polarizing beam splitter 3124, and the light receiving element 3125L detects the other component of the optical pulse polarization-split by the polarizing beam splitter 3124.

### 2-2. Communication Operation Between IC Card and Terminal Device

Next, a description will be made in connection with a quantum communication operation and a classical communication operation performed between the IC card 21 and the terminal device 31.

[Quantum Communication Operation]

In quantum communication of the BB84 protocol, the modulating unit 212 (for example, the liquid crystal retarder) of the IC card 21 is randomly controlled by the control unit 216 according to arrival timing of the optical pulse such that a phase difference φ between the polarization component parallel to the FAST axis and the polarization component parallel to the SLOW axis is set to any one of 0°, 90°, 180°, and 270°.

The polarization state of the optical pulse having passed through the modulating unit 212 is linearly polarized light which is incident light when the phase difference φ is 0°, is changed to linearly polarized light perpendicular to the incident linearly polarized light when the phase difference φ is 180°, and is changed to circularly polarized light when the phase difference φ is 90° or 270°. Here, the circularly polarized light when the phase difference φ is 90° is opposite in direction to the circularly polarized light when the phase difference φ is 270°. Further, when the phase differences φ are 90° and 270°, whether the polarization states of the optical pulses are left-handed circularly polarized light and right-handed circularly polarized light or right-handed circularly polarized light and left-handed circularly polarized light is decided depending on a direction of the optical axis (the SLOW axis and the FAST axis) of the arranged liquid crystal retarder.

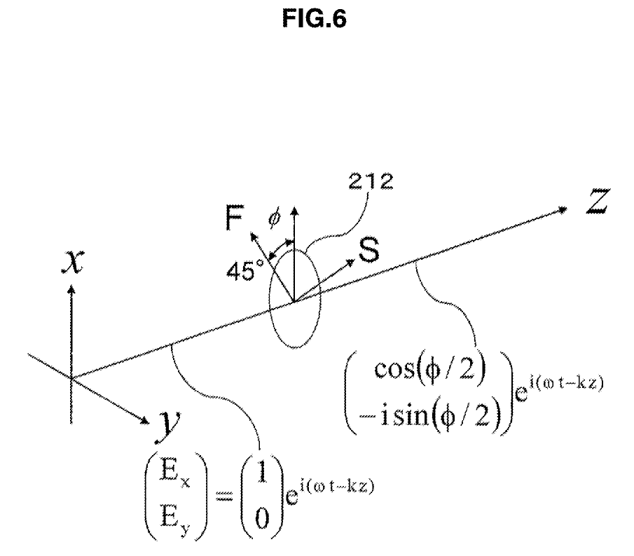

FIG. 6 illustrates polarization modulation performed by the modulating unit 212. Linearly polarized light in an x direction illustrated in FIG. 6 is referred to as “vertically polarized light.” Further, the position inclined at 45° with respect to an axis in the x direction is used the FAST axis of the modulating unit 212. The FAST axis of the modulating unit 212 is designated as “F”, and the SLOW axis thereof is designated as “S.”

In this case, when the phase difference φ between the polarization component parallel to the FAST axis of the modulating unit 212 and the polarization component parallel to the SLOW axis is set to 0°, the optical pulse having passed through the modulating unit 212 becomes vertically polarized light. Further, when the phase difference φ is set to 90°, the optical pulse becomes left-handed circularly polarized light. Further, when the phase difference φ is set to 180°, the optical pulse becomes horizontally polarized light. Further, when the phase difference φ is set to 270°, the optical pulse becomes right-handed circularly polarized light.

As described above, the optical pulse whose polarization state is randomly controlled to any one of four polarization states by the control unit 216 is output to the terminal device 31.

The terminal device 31 generates the optical pulse through the light source unit 311. At this time, it is desirable that the number of photons per pulse is 1 or less (the number of photons per pulse can be 1 or less using a light reduction means such as a neutral density (ND) filter when intensity of an optical pulse from the semiconductor light-emitting element is strong).

The non-polarizing beam splitter 3121 of the optical unit 312a splits an optical pulse supplied from the IC card 21. One component of the optical pulse split by the non-polarizing beam splitter 3121 is incident to the polarizing beam splitter 3122, is split according to a polarization component, and then is incident to the light receiving element 3125H or the light receiving element 3125V.

The other component of the optical pulse split by the non-polarizing beam splitter 3121 changes in a polarization state while passing through the ¼ wave plate 3123, is incident to the polarizing beam splitter 3124, is split according to a polarization component, and then is incident to the light receiving element 3125R or the light receiving element 3125L. In the above description, it is described that the optical pulse is split; however, actually (if there is no noise), it is difficult for all light receiving elements to detect one optical pulse. It is because, since intensity of the optical pulse is set so that the number of photons per pulse can be 1 or less, a photon is detected by any one of four light receiving elements and converted into an electric signal.

Table 1 represents an optical pulse detection probability of a light receiving element for each polarization state. In Table 1, the number of photons per pulse is “1”, a split ratio of the non-polarizing beam splitter 3121 is p:(1−p) (Here, 0<p<1). That is, Table 1 represents a value of an ideal case where there is no light loss neither eavesdropping.

TABLE 1

| | | Light Receiving Element 3125 | | | |
|---|---|---|---|---|---|
| | | V | H | L | R |
| Polarization State of | V | p | 0 | 0.5 (1 − p) | 0.5 (1 − p) |
| Transmitted Optical Pulse | H | 0 | p | 0.5 (1 − p) | 0.5 (1 − p) |
| | L | 0.5 p | 0.5 p | (1 − p) | 0 |
| | R | 0.5 p | 0.5 p | 0 | (1 − p) |

When the non-polarizing beam splitter 3121 turns an optical pulse of vertically polarized light V or horizontally polarized light H in a direction of the light receiving element 3125H or the light receiving element 3125V, a probability is “p” and is detected by the corresponding light receiving element. That is, when the optical pulse is the vertically polarized light V, a probability that the optical pulse will be detected by the light receiving element 3125V is “p,” and a probability that the optical pulse will be detected by the light receiving element 3125H is “0.” Further, when the optical pulse is the horizontally polarized light H, a probability that the optical pulse will be detected by the light receiving element 3125V is “0”, and a probability that the optical pulse will be detected by the light receiving element 3125H is “p.”

Further, when an optical pulse of vertically polarized light V or horizontally polarized light H is turned in a direction of the light receiving element 3125L or the light receiving element 3125R by the non-polarizing beam splitter 3121, a probability is “1−p.” Further, since probabilities that the optical pulse will be detected by all light receiving elements are all “0.5,” probabilities that the optical pulse will be detected by the light receiving elements 3125L and 3125R are “0.5(1−p)” regardless whether the optical pulse is the vertically polarized light V or the horizontally polarized light H.

Similarly, when the optical pulse is left-handed circularly polarized light L, a probability that the optical pulse will be detected by the light receiving element 3125L is “1−p,” a probability that the optical pulse will be detected by the light receiving element 3125R is “0.” Further, when the optical pulse is right-handed circularly polarized light R, a probability that the optical pulse will be detected by the light receiving element 3125L is “0,” and a probability that the optical pulse will be detected by the light receiving element 3125R is “1−p.” Furthermore, probabilities that the optical pulse will be detected by the light receiving elements 3125V and 3125H are “0.5 p” regardless whether the optical pulse is the left-handed circularly polarized light L or the right-handed circularly polarized light R. In the BB84 protocol, a portion that performs quantum communication repetitively performs the above described operation, and outputs the light receiving results of the light receiving elements 3125V, 3125H, 3125L, and 3125R to the control unit 316.

[Classical Communication Operation]

Next, after the quantum communication in the BB84 protocol, classical communication is executed. The IC card 21 and the terminal device 31 execute the following protocol using a public communication path (that is, communication contents are not encrypted, and even an eavesdropper can know all communication contents).

(1) Base Exchange

The terminal device 31 performs communication with the IC card 21 via a public communication path such as the classical communication path 55, and transmits only information representing whether linearly polarized light has been detected or circularly polarized light has been detected among the reception results of the quantum communication from the control unit 316 to the control unit 216 via the communication unit 315 and the communication unit 215 of the IC card 21. For example, when the vertically polarized light V has been detected, only information representing “linearly polarized light has been detected” other than information representing “vertically polarized light V has been detected” is transmitted. The control unit 216 of the IC card 21 detects a time at which a correct reception result is obtained, and notifies the control unit 316 of the terminal device 31 of the detection result. The control unit 316 selects only correct data based on the notified detection result. In other words, when the IC card 21 transmits an optical pulse of linearly polarized light (vertically polarized light V or horizontally polarized light H) but the terminal device 31 detects circularly polarized light (left-handed circularly polarized light L or right-handed circularly polarized light R), it is difficult to generate shared secret information. Further, even when the IC card 21 transmits an optical pulse of circularly polarized light L or R but the terminal device 31 detects linearly polarized light V or H, it is difficult to generate shared secret information. Thus, these data are discarded. Further, based on the remaining data, a correlated random bit string can be shared between the IC card and the terminal device, for example, such that the vertically polarized light V and the horizontally polarized light H are set to “0” and “1,” respectively, in case of linearly polarized light and the left-handed circularly polarized light L and the right-handed circularly polarized light R are set to “0” and “1,” respectively, in case of circularly polarized light. Based on the random bit string, the IC card 21 and the terminal device 31 generate a common key.

On the other hand, the IC card 21 may transmit only information representing “whether linearly polarized light has been transmitted or circularly polarized light has been transmitted” from the control unit 216 to the control unit 316 via the communication unit 215 and the communication unit 315 of the terminal device 31, and the control unit 316 of the terminal device 31 may select only correct data based on the notified base.

However, the bit string shared between the IC card 21 and the terminal device 31 may include an error occurring in the quantum communication path 51 or an error occurring at the time of transmission and reception. Further, an error occurs in the shared bit string even when an eavesdropper present in the middle of the quantum communication path 51 has peeped at photon information. Thus, error rate estimation, error correction, and privacy amplification are performed.

(2) Error Rate Estimation

In error rate estimation, data is randomly selected from the bit string obtained by the base exchange. For example, about half is randomly selected from data when the IC card 21 transmits an optical pulse of linearly polarized light V or H and the terminal device 31 detects linearly polarized light V or H, and about half is randomly selected from data when the IC card 21 transmits an optical pulse of circularly polarized light L or R and the terminal device 31 detects circularly polarized light L or R. A value of randomly selected data is checked, and an error rate is estimated. Data used for error rate estimation is deleted from the bit string.

(3) Error Correction

In error correction, the bit string from which data used for error rate estimation has been deleted is subjected to error correction. For example, in error correction, the bit string is divided into a plurality of blocks, a block including an error is specified by checking parity of each block, and error correction is performed by applying a hamming code to the specified block.

(4) Privacy Amplification

In privacy amplification, the bit string which has been subjected to error correction is subjected to privacy amplification according to the estimated error rate. At this time, an error may be caused by the IC card 21, the terminal device 31, or due to influence of a noise in the quantum communication path even though an eavesdropper is not present. However, in order to increase security, it is assumed that all errors are caused by eavesdropping. In other words, it is regarded that an error has occurred due to eavesdropping, an amount of information leaked to an eavesdropper is estimated based on the error rate, conversion is performed to reduce the bit string by the information amount, and an information amount of an eavesdropper related to the reduced bit string is ignored.

When this process is performed, for example, a bit string larger than 1 is obtained when the error rate is small (for example, about 11% or less in the case of BB84). The obtained bit string is held in the memory unit 213 of the IC card 21 and the memory unit 313 of the terminal device 31 as a common key. When the error rate is large and so the length of the bit string becomes 0, the key distribution fails.

To help with understanding, the above description has been made in connection with the example in which a quantum communication part and a classical communication part are performed in order. However, actually, it is desirable that the quantum communication part is continuously performed, and when a certain amount of data is accumulated, the classical communication part is sequentially performed as necessary. It is because an amount of a common key obtained per unit time increases.

The common key stored in the IC card 21 and the terminal device 31 is used as necessary when encryption of communication is necessary. For example, when communication is performed using the common key cryptosystem, an amount of information encrypted using one common key is decided in advance. Here, when a communication volume is larger than a set communication volume, the IC card 21 and the terminal device 31 simultaneously take the common key out of their memory units, and update a key for common key encryption. Alternatively, when a communication volume is almost constant and does not greatly change, the IC card 21 and the terminal device 31 simultaneously take the common key out of their memory units at predetermined time intervals, and update a key used for the common key cryptosystem.

By configuring the IC card 21 and the terminal device 31 as described above, the optical pulse output from the light source unit 311 of the terminal device 31 is modulated by the modulating unit 212 of the IC card 21. Further, the modulation state of the modulated optical pulse is analyzed by the modulation analyzing unit 312 of the terminal device 31, and then the quantum cryptography communication can be performed. Further, since the quantum cryptography communication can be performed, the common key can be safely generated and used, and thus communication used for the common key cryptosystem can be safely performed.

### 2-3. Second Structure Example of IC Card and Terminal Device According to First Embodiment

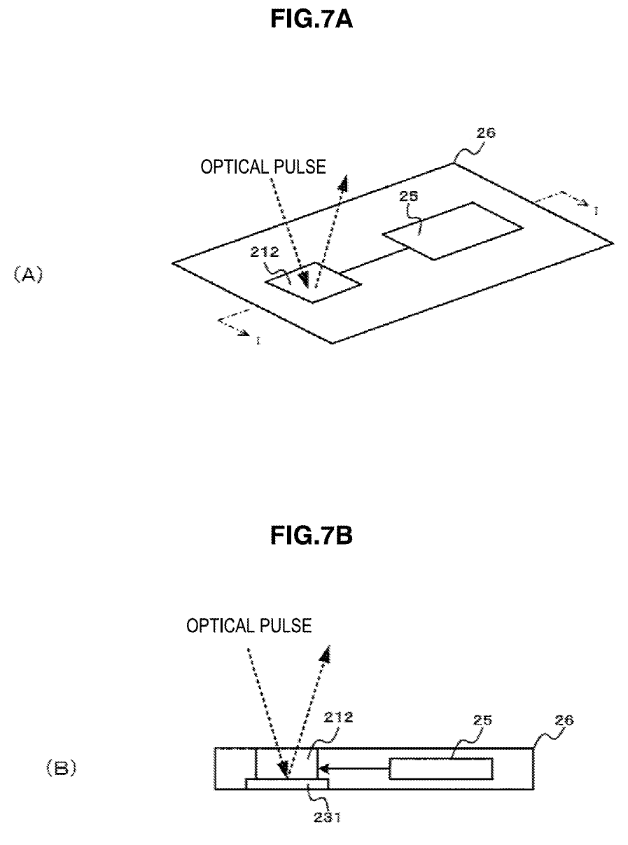

FIGS. 7A and 7B illustrate a second structure example of an IC card according to the first embodiment. FIG. 7A is a perspective view of an IC card, and FIG. 7B is a schematic cross-sectional view taken along line I-I in the IC card of FIG. 7A. Similarly to the first structure example, the IC card 21 is configured such that the substrate 25 provided with a memory unit and the like is interposed between outer sheets 26. A mounting portion for mounting the modulating unit 212 is formed in the outer sheet 26. The mounting portion may be a through hole or a concave hole.

A reflecting unit 231 is arranged on a surface opposite to an optical pulse input surface of the modulating unit 212. Thus, the optical pulse input to the input surface of the modulating unit 212 is reflected by the reflecting unit 231 and then output from the input surface. Further, the optical pulse output from the input surface is an optical pulse modulated by the modulating unit 212.

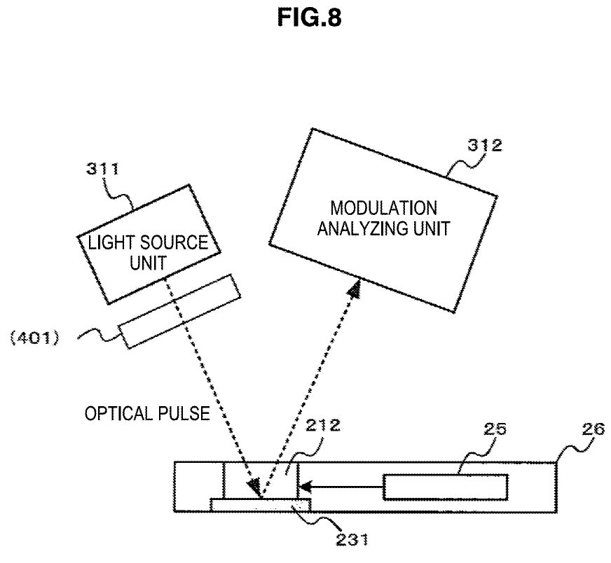

FIG. 8 illustrates a second structure example of the terminal device according to the first embodiment. In the terminal device 31, the light source unit 311 and the modulation analyzing unit 312 are arranged at the input surface side of the modulating unit 212 in the IC card 21. The light source unit 311 is set to input an output optical pulse to the input surface of the modulating unit 212. Further, the modulation analyzing unit 312 is set to receive the optical pulse which has been reflected by the reflecting unit 231 of the IC card 21 and then output from the input surface of the modulating unit 212. Further, the polarizer 401 may be arranged between the light source unit 311 and the modulating unit 212.

By configuring the IC card 21 and the terminal device 31 as described above, the optical pulse output from the light source unit 311 of the terminal device 31 is modulated by the modulating unit 212 of the IC card 21, and the modulation state of the modulated optical pulse is analyzed by the modulation analyzing unit 312 of the terminal device 31. Even in the second structure example, similarly to the first structure example, since the quantum cryptography communication can be performed, the common key can be safely generated and used, and thus communication used for the common key cryptosystem can be safely performed. Further, the light source unit 311 and the modulation analyzing unit 312 of the terminal device 31 are arranged at one surface side of the IC card 21, and thus the terminal device 31 becomes more compact than the first structure example.

### 2-4. Third Structure Example of IC Card and Terminal Device According to First Embodiment

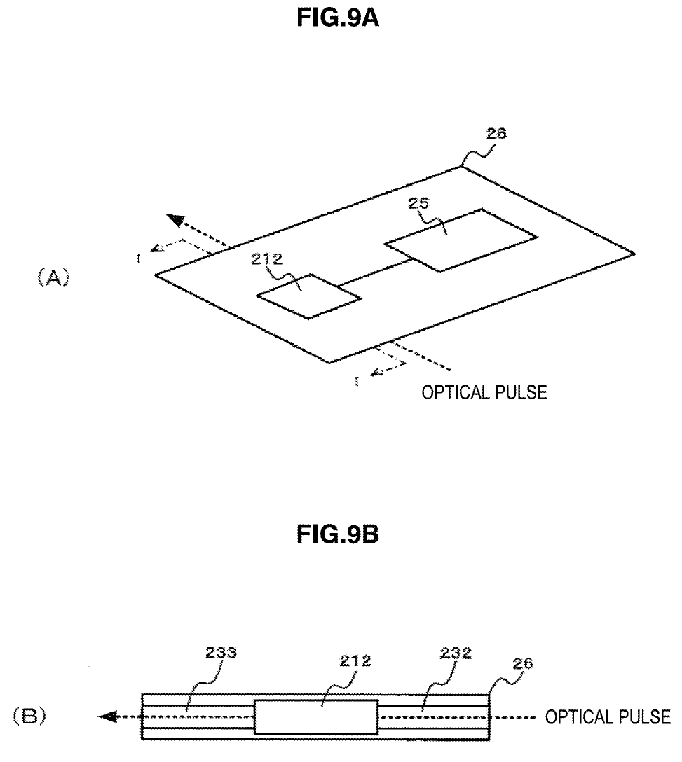

FIGS. 9A and 9B illustrate a third structure example of an IC card according to the first embodiment. FIG. 9A is a perspective view of an IC card, and FIG. 9B is a schematic cross-sectional view taken along line I-I in the IC card of FIG. 9A.

Similarly to the first structure example, the IC card 21 is configured such that the substrate 25 provided with a memory unit and the like is interposed between outer sheets 26. Further, the modulating unit 212 is arranged between the outer sheets 26, and waveguides 232 and 233 are arranged at an input surface side and an output surface side of the modulating unit 212, respectively. One end of the waveguide 232 becomes an input surface (or an output surface side) of the modulating unit 212, and the other end becomes the position of an end surface of the IC card 21. One end of the waveguide 233 becomes an output surface (or an input surface side) of the modulating unit 212, and the other end becomes the position of an end surface of the IC card 21.

The modulating unit 212 is not limited to a liquid crystal retarder that performs polarization modulation, and a modulator that performs phase modulation may be used as the modulating unit 212. An electro-optical modulator using an electro-optic (EO) polymer may be used as the phase modulator.

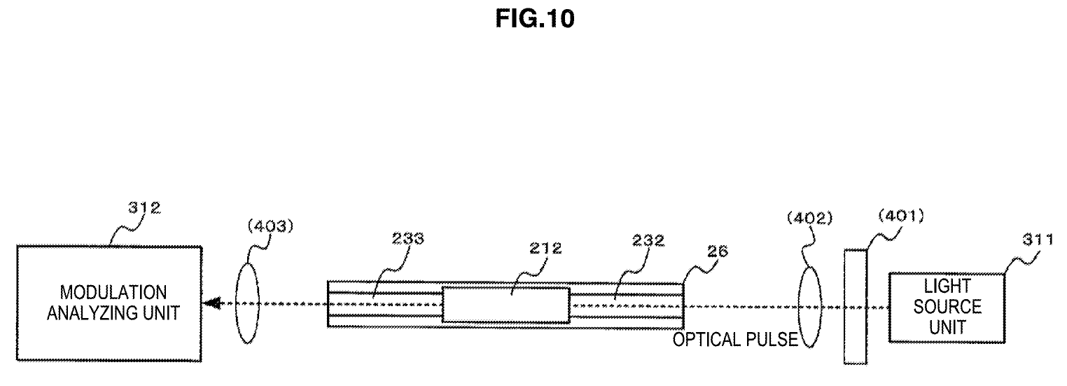

FIG. 10 illustrates a third structure example of the terminal device according to the first embodiment. In the terminal device 31, the light source unit 311 and the modulation analyzing unit 312 are arranged to face each other. The light source unit 311 is arranged at one end surface side of the IC card 21, the optical pulse output from the light source unit 311 is input from the end surface of the IC card 21 to the modulating unit 212 via the waveguide 232. Further, the modulation analyzing unit 312 is arranged on the other end surface side of the IC card 21, and receives light which has been modulated by the modulating unit 212 and output via the waveguide 232.

Further, the polarizer 401 may be arranged between the light source unit 311 and the modulating unit 212. Further, since the optical pulse is input to the end surface of the IC card 21, the optical pulse may be condensed using the lens 402 before the optical pulse may be input. Further, since the optical pulse is output from the end surface of the IC card 21, the optical pulse may be supplied to the modulation analyzing unit 312 using a lens 403.

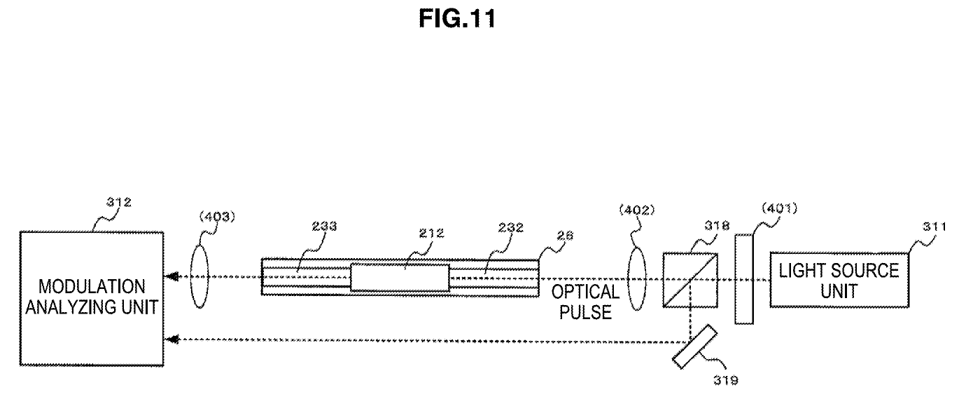

FIG. 11 illustrates a third structure example of the terminal device when a phase modulator is used as the modulating unit 212 of the IC card 21. When phase modulation of the optical pulse is performed, the terminal device performs modulation analysis using the principle of a Mach-Zehnder (MZ) interferometer.

In the terminal device 31, the light source unit 311 and the modulation analyzing unit 312 are arranged to face each other. The light source unit 311 is arranged at one end surface side of the IC card 21, and the optical pulse output from the light source unit 311 is input from the end surface of the IC card 21 to the modulating unit 212 via the waveguide 232. Further, the modulation analyzing unit 312 is arranged at the other end surface side of the IC card 21, and receives light which has been modulated by the modulating unit 212 and then output via the waveguide 232. Further, the terminal device 31 is provided with a beam splitter 318 and a mirror 319. The beam splitter 318 splits the optical pulse output from the light source unit 311 to the end surface of the IC card 21, and outputs the split optical pulse to the mirror 319. The mirror 319 changes an optical path of the optical pulse so that the optical pulse split by the beam splitter 318 can be input to the modulation analyzing unit 312.

Further, the polarizer 401 may be arranged between the light source unit 311 and the modulating unit 212. Further, since the optical pulse is input to the end surface of the IC card 21, the optical pulse may be condensed using the lens 402 before the optical pulse may be input. Further, since the optical pulse is output from the end surface of the IC card 21, the optical pulse may be supplied to the modulation analyzing unit 312 using the lens 403.

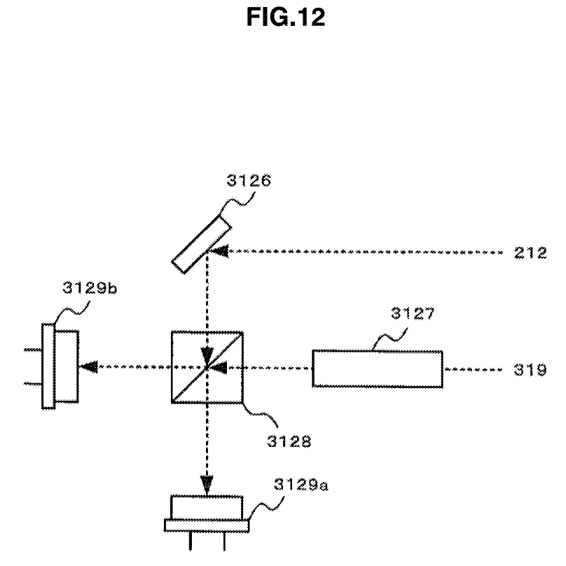

FIG. 12 illustrates a configuration of the modulation analyzing unit 312 when phase modulation is used. The optical unit 312a of the modulation analyzing unit 312 includes a mirror 3126 and a beam splitter 3128. Further, the optical unit 312a is provided with a phase modulator 3127.

The mirror 3126 changes an optical path of the optical pulse so that the optical pulse from the IC card 21 can be input to the beam splitter 3128. The phase modulator 3127 performs phase modulation of the optical pulse whose optical path has been changed by the mirror 319, and outputs the optical pulse whose phase has been modulated to the beam splitter 3128. The beam splitter 3128 splits the optical pulse whose optical path has been changed by the mirror 3126 and the optical pulse output from the phase modulator 3127, and outputs the splits optical pulses to light receiving elements 3129a and 3129b of the light receiving unit 312b.

The light receiving elements 3129a and 3129b detect the optical pulses split by the beam splitter 3128.

By configuring the IC card 21 and the terminal device 31 as described above, the optical pulse output from the light source unit 311 of the terminal device 31 is modulated by the modulating unit 212 of the IC card 21, and the modulation state of the modulated optical pulse is analyzed by the modulation analyzing unit 312 of the terminal device 31. Even in the third structure example, similarly to the first and second structure examples, since the quantum cryptography communication can be performed, the common key can be safely generated and used, and thus communication used for the common key cryptosystem can be safely performed. Further, even though the surface of the IC card 21 is not used as in the first and second structure examples, the quantum cryptography communication can be performed.

[Quantum Communication Operation when Phase Modulation is Used]

When phase modulation is used, the modulating unit 212 of the IC card 21 randomly selects a phase shift amount from among a plurality of previously set phase shift amounts, for example, “0, π/2, π, and 3π/2,” based on a control signal from the control unit 216, and then performs phase modulation of the optical pulse.

The phase modulator 3127 of the modulation analyzing unit 312 randomly selects a phase shift amount from among a plurality of previously set phase shift amounts, for example, “0 and π/2,” associated with the phase shift amount of the modulating unit 212 of the IC card 21 based on a control signal from the control unit 316, and then performs phase modulation of the optical pulse.

The light receiving elements 3129a and 3129b receive the optical pulses split by the beam splitter 3128. Here, since one or less photon is present in the optical pulse, the optical pulse is received by either of the light receiving element 3129a and the light receiving element 3129b.

Table 2 represents a relation among a phase shift amount of the modulating unit 212, a phase shift amount of the modulation analyzing unit 312, and a light receiving element receiving an optical pulse. When the phase shift amount of the modulating unit 212 is equal to the phase shift amount of the modulation analyzing unit 312, the optical pulse is detected by the light receiving element 3129a. When the phase shift amount of the modulating unit 212 and the phase shift amount of the modulation analyzing unit 312 are “π,” the optical pulse is detected by the light receiving element 3129b. In the other cases, that is, in case of a combination of a mark “*,” it is known that probabilities that the optical pulse is detected by the light receiving elements 3129a and 3129b are equal.

TABLE 2

| | | Phase Shift Amount of Modulating Unit | | | |
|---|---|---|---|---|---|
| | | 0 | π/2 | π | 3π/2 |
| | | (a) | (b) | (a) | (b) |
| Phase Shift | 0 | Light | * | Light | * |
| Amount of | (a′) | Receiving | | Receiving | |
| Modulation | | Element | | Element | |
| Analyzing unit | | 3129a | | 3129b | |
| | π/2 | * | Light | * | Light |
| | (b′) | | Receiving | | Receiving |
| | | | Element | | Element |
| | | | 3129a | | 3129b |

Here, information representing which of (a) and (b) in (a){0,π} and (b){π/2,3π/2} is used by the IC card 21 and information representing which of (a′){0} and (b′){π/2} is used by the terminal device 31 are checked, and then combinations of “*”, that is, combinations of (a)-(b′) and (b)-(a′) is excluded in Table 2.

The terminal device 31 generates “0” when the light receiving element 3129a of the modulation analyzing unit 312 detects the optical pulse and generates “1” when the light receiving element 3129b detects the optical pulse. In the case of (a)-(a′), the IC card 21 generates “0” when the phase shift amount of the modulating unit 212 is “0” and generates “1” when the phase shift amount of the modulating unit 212 is “π.” In the case of (b)-(b′), the IC card 21 generates “0” when the phase shift amount of the modulating unit 212 is “π/2” and generates “1” when the phase shift amount of the modulating unit 212 is “3π/2.” In this way, the IC card 21 and the terminal device 31 can generate shared secret information.

### 2-5. Fourth Structure Example of IC Card and Terminal Device According to First Embodiment

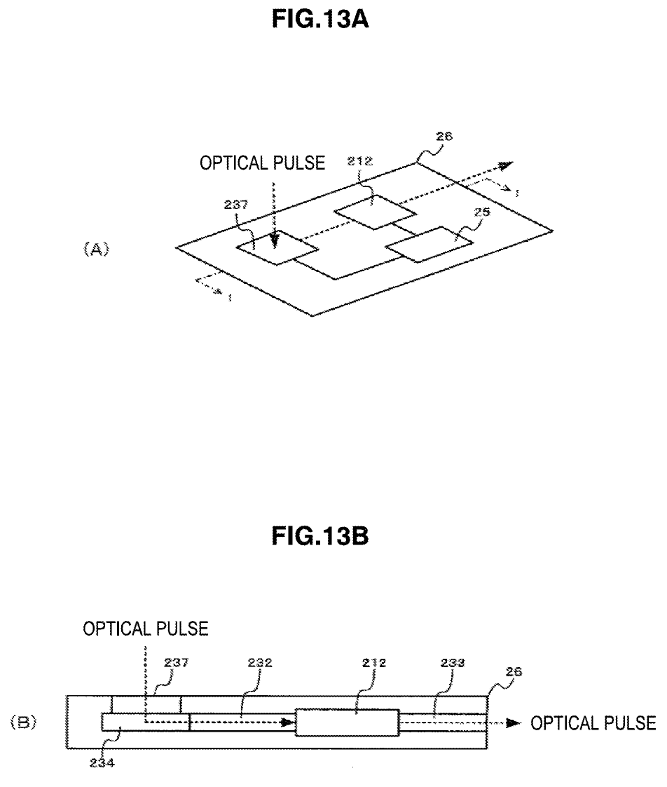

FIGS. 13A and 13B illustrate a fourth structure example of an IC card according to the first embodiment. FIG. 13A is a perspective view of an IC card, and FIG. 13B is a schematic cross-sectional view taken along line I-I in the IC card of FIG. 13A.

Similarly to the first structure example, the IC card 21 is configured such that the substrate 25 provided with a memory unit and the like is interposed between outer sheets 26. In the fourth structure example, the IC card 21 is provided with a polarization modulator or a phase modulator as the modulating unit 212.

A window 237 for inputting an optical pulse is formed in the outer sheet 26. An optical path converting unit 234 that bends an optical path is arranged at an opposite surface side to an optical pulse input surface of the window 237. The window 237 is made of a material such as glass or plastic transparent to a wavelength of an optical pulse.

The optical path converting unit 234 is configured with a mirror or a hologram. The optical path converting unit 234 bends an optical path of an optical pulse having passed through the window 237, and outputs the optical pulse to the modulating unit 212 via the waveguide 232. The optical pulse modulated by the modulating unit 212 is output from the end surface of the IC card 21 via the waveguide 233.

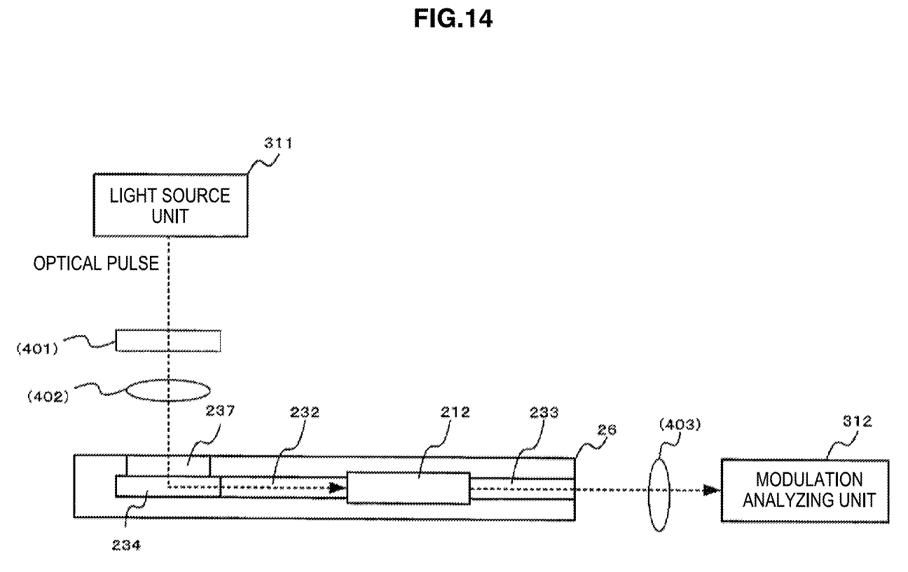

FIG. 14 illustrates a fourth structure example of the terminal device according to the first embodiment. In the terminal device 31, the light source unit 311 is arranged at the optical pulse input surface side of the window 237 in the IC card 21. Further, the modulation analyzing unit 312 is set to receive the optical pulse output from the end surface of the IC card 21.

Further, the polarizer 401 may be arranged between the light source unit 311 and the window 237. Further, an optical pulse may be condensed using the lens 402, and then the condensed optical pulse may be input to the widow 237. Further, since the optical pulse is output from the end surface of the IC card 21, the optical pulse may be supplied to the modulation analyzing unit 312 using the lens 403.

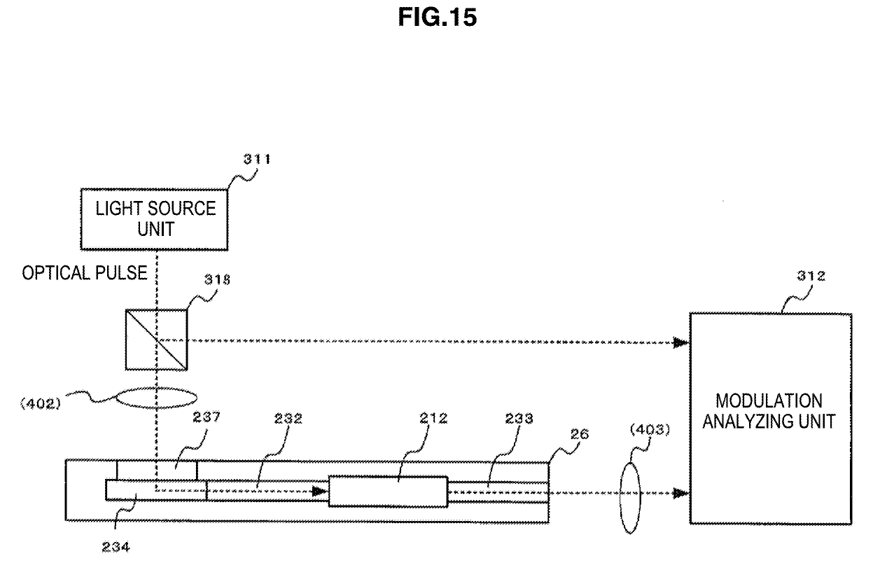

FIG. 15 illustrates the fourth structure example of the terminal device when the phase modulator is used as the modulating unit 212 of the IC card 21. When phase modulation of the optical pulse is performed, the terminal device performs modulation analysis using the principle of the MZ interferometer.

In the terminal device 31, the light source unit 311 is arranged at the optical pulse input surface side at which the window 237 of the IC card 21 is formed. Further, the modulation analyzing unit 312 is set to receive the optical pulse which has been modulated by the modulating unit 212 of the IC card 21 and then output from the end surface via the waveguide 233. Further, the terminal device 31 is provided with the beam splitter 318. The beam splitter 318 splits the optical pulse to be output from the light source unit 311 to the window 237 of the IC card 21, and outputs the split optical pulse to the modulation analyzing unit 312.

Further, since the optical pulse is input to the window 237 of the IC card 21, the optical pulse may be condensed using the lens 402 before the optical pulse may be input. Further, since the optical pulse is output from the end surface of the IC card 21, the optical pulse may be supplied to the modulation analyzing unit 312 using the lens 403.

By configuring the IC card 21 and the terminal device 31 as described above, the optical pulse output from the light source unit 311 of the terminal device 31 is modulated by the modulating unit 212 of the IC card 21, and the modulation state of the modulated optical pulse is analyzed by the modulation analyzing unit 312 of the terminal device 31. Even in the fourth structure example, similarly to the first to third structure examples, since the quantum cryptography communication can be performed, the common key can be safely generated and used, and thus communication used for the common key cryptosystem can be safely performed. Further, modulation of an optical pulse can be performed using the polarization modulator or the phase modulator as the modulating unit 212.

### 3. Overall Configuration According to Second Embodiment

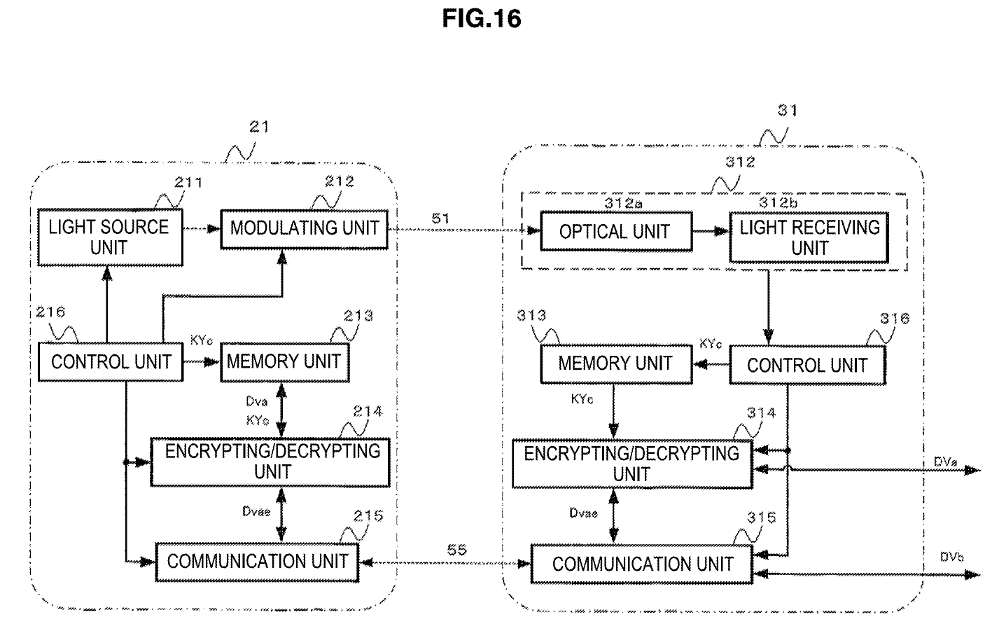

Next, the second embodiment will be described in connection with an example in which an IC card is provided with a light source unit, and the quantum cryptography communication is performed such that an optical pulse output from the light source unit is modulated and then output. FIG. 16 is a diagram illustrating an overall configuration according to the second embodiment. Similarly to the first embodiment, the IC card 21 is connected with the terminal device 31 via the quantum communication path 51 and the classical communication path 55.

The IC card 21 includes a light source unit 211, a modulating unit 212, a memory unit 213, an encrypting/decrypting unit 214, a communication unit 215, and a control unit 216

The light source unit 211 is configured with a semiconductor light-emitting element such as a laser diode or an LED. The light source unit 211 outputs an optical pulse emitted from the semiconductor light-emitting element to the modulating unit 212. Further, the light source unit 211 performs output control of an optical pulse through the control unit 216. Further, the light source unit 211 may be provided with a lens for collimating an optical pulse emitted from the semiconductor light-emitting device.

The modulating unit 212 changes, for example, a polarization state of an optical pulse output from the light source unit 211 to any one of a plurality of previously set polarization bases. The modulating unit 212 is configured with a variable wave plate such as a liquid crystal retarder. The modulating unit 212 performs polarization modulation based on a control signal from the control unit 216, changes a polarization state of an optical pulse emitted from the light source unit 211 to any one of a plurality of polarization bases previously set based on a control signal at a high speed, and supplies the terminal device 31 with the polarization base via the quantum communication path 51.

The memory unit 213 stores a common key KYc generated by the control unit 216 or various pieces of information. The encrypting/decrypting unit 214 encrypts/decrypts information DVa/encrypted information DVae stored in the memory unit 213 using the common key KYc stored in the memory unit 213.

The communication unit 215 transmits information DVb that does not use a cipher or the information DVae encrypted by the encrypting/decrypting unit 214 to the terminal device 31 via the classical communication path 55. Further, the communication unit 215 receives information transmitted from the terminal device 31 via the classical communication path 55. When the received information is non-encrypted information, the communication unit 215 stores the received information, for example, in the memory unit 213. However, when the received information is encrypted information, the communication unit 215 supplies the received information DVae to the encrypting/decrypting unit 214. Thus, the decrypted information DVa is supplied from the encrypting/decrypting unit 214 to the memory unit 213 and then stored in the memory unit 213.

The control unit 216 performs control of a modulation process which the modulating unit 212 performs on an output of an optical pulse from the light source unit 211 or an optical pulse output from the terminal device 31 so as to perform the quantum cryptography communication. Further, the control unit 216 performs communication with the terminal device 31 via the communication unit 215 or the classical communication path 55. Furthermore, the control unit 216 performs a process of generating a common key based on a communication result of the quantum cryptography communication, communication control of information, control of encryption or decryption using a common key, and the like.

The terminal device 31 includes a light source unit 311, a modulation analyzing unit 312, a memory unit 313, an encrypting/decrypting unit 314, a communication unit 315, and a control unit 316.

The modulation analyzing unit 312 includes an optical unit 312a and a light receiving unit 312b. The optical unit 312a sorts an optical pulse, which has been subjected polarization modulation, supplied from the IC card 21 via the quantum communication path 51 according to each polarization base. The light receiving unit 312b detects the optical pulse which is sorted according to each polarization base for each polarization base, and outputs the detection result to the control unit 316.

The memory unit 313 stores the common key KYc which the control unit 316 has generated based on the detection result from the light receiving unit 312b. Further, the encrypting/decrypting unit 314 encrypts the information DVa using a cipher or decrypts the encrypted information DVae using the common key KYc stored in the memory unit 313.

The communication unit 315 transmits the information DVb that does not use a cipher or the information DVae encrypted by the encrypting/decrypting unit 314 to the IC card 21 via the classical communication path 55. Further, the communication unit 315 receives information transmitted from the IC card 21 via the classical communication path 55. When the received information is non-encrypted information, the communication unit 315 supplies the received information DVb to a signal processing unit (not shown). However, when the received information is encrypted information, the communication unit 315 supplies the received information DVae to the encrypting/decrypting unit 314. Thus, the decrypted information DVa is supplied from the encrypting/decrypting unit 314 to the signal processing unit.

The control unit 316 performs communication with the IC card 21 via the communication unit 315 or the classical communication path 55 using the detection result of the light receiving unit 312b. Furthermore, the control unit 316 performs a process of generating a common key based on a communication result of the quantum cryptography communication, communication control of information, control of encryption or decryption using a common key, and the like.

### 3-1. First Structure Example of IC Card and Terminal Device According to Second Embodiment

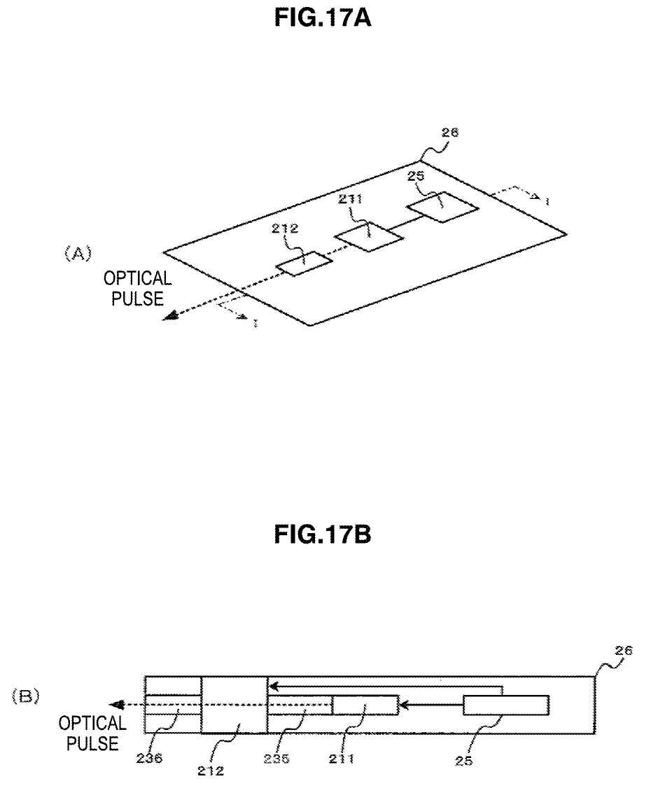

FIGS. 17A and 17B illustrate a first structure example of an IC card according to the second embodiment. FIG. 17A is a perspective view of an IC card, and FIG. 17B is a schematic cross-sectional view taken along line I-I in the IC card of FIG. 17A.

The IC card 21 is configured such that a substrate 25 provided with the memory unit 213, the encrypting/decrypting unit 214, the communication unit 215, and the control unit 216 illustrated in FIG. 2 is interposed between outer sheets 26. Further, the light source unit 211 and the modulating unit 212 are interposed between the outer sheets 26. A waveguide 235 is formed between the light source unit 211 and the modulating unit 212. Further, a waveguide 236 is formed between the modulating unit 212 and the end surface of the IC card 21. The light source unit 211 is configured with an edge-emission type light-emitting element. The light source unit 211 supplies an optical pulse to the modulating unit 212 via the waveguide 235. The modulating unit 212 modulates the optical pulse supplied from the light source unit 211 and outputs a modulated optical pulse from the other surface of the IC card 21 via the waveguide 236.

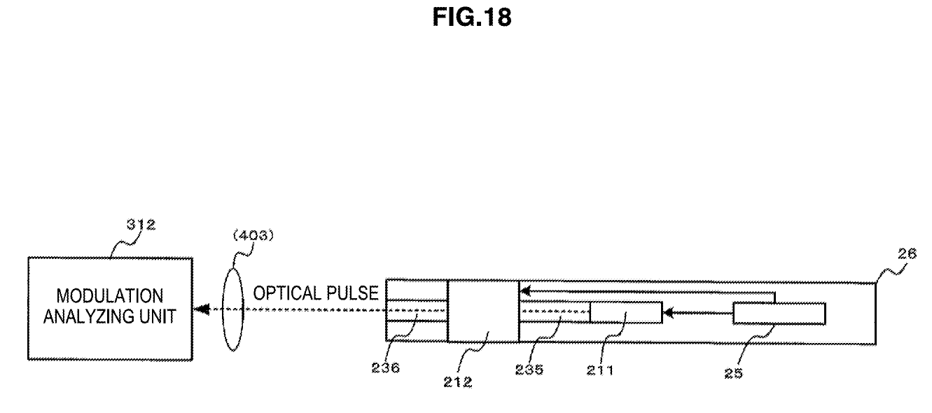

FIG. 18 illustrates a first structure example of the terminal device according to the second embodiment. In the terminal device 31, the modulation analyzing unit 312 is arranged to face the end surface of the IC card 21 through which the optical pulse is output, and receives the optical pulse output from the end surface of the IC card 21. Further, since the optical pulse is output from the end surface of the IC card 21, the optical pulse may be supplied to the modulation analyzing unit 312 using a lens 403.

By configuring the IC card 21 and the terminal device 31 as described above, the optical pulse output from the light source unit 211 of the IC card 21 is modulated by the modulating unit 212 and then supplied to the terminal device 31. Further, the terminal device 31 analyzes the modulation state of the modulated optical pulse through the modulation analyzing unit 312 and can perform the quantum cryptography communication. Further, since the quantum cryptography communication can be performed, the common key can be safely generated and used, and thus communication used for the common key cryptosystem can be safely performed.

### 3-2. Second Structure Example of IC Card and Terminal Device According to Second Embodiment

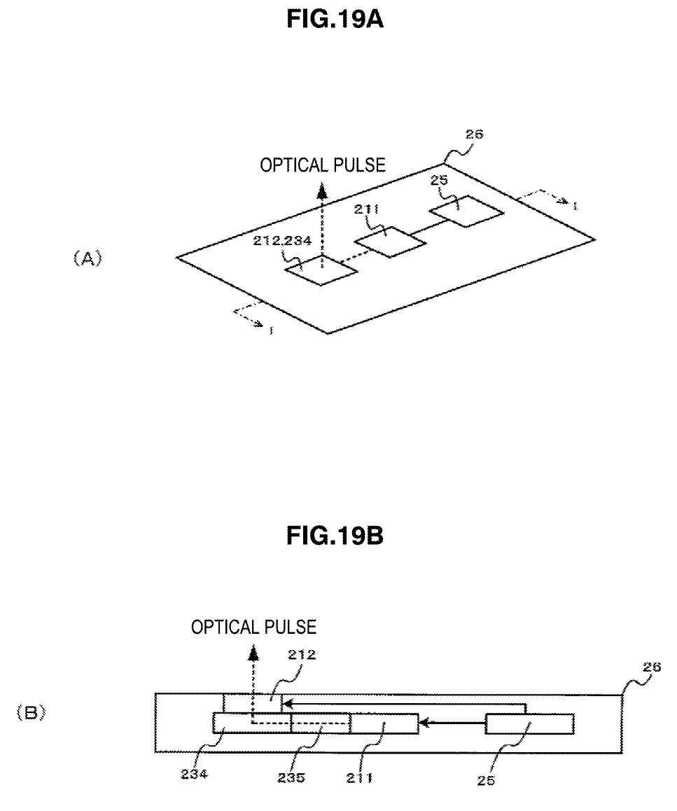

FIGS. 19A and 19B illustrate a second structure example of an IC card according to the second embodiment. FIG. 19A is a perspective view of an IC card, and FIG. 19B is a schematic cross-sectional view taken along line I-I in the IC card of FIG. 19A.

Similarly to the first structure example, the IC card 21 is configured such that the substrate 25 provided with the memory unit 213 and the like and the light source unit 211 are interposed between outer sheets 26. A mounting portion for mounting the modulating unit 212 is formed in the outer sheet 26, and the modulating unit 212 is mounted to the mounting portion. The optical path converting unit 234 that bends an optical path is arranged on an optical pulse input surface of the modulating unit 212. A waveguide 235 is formed between the light source unit 211 and the optical path converting unit 234. The light source unit 211 supplies an optical pulse to the optical path converting unit 234 via the waveguide 235. The optical path converting unit 234 bends the optical path of the optical pulse and supplies the resultant optical pulse to the modulating unit 212. The modulating unit 212 modulates the optical pulse supplied from the optical path converting unit 234, and outputs the modulated optical pulse, for example, in a direction vertical to the surface of the IC card 21.

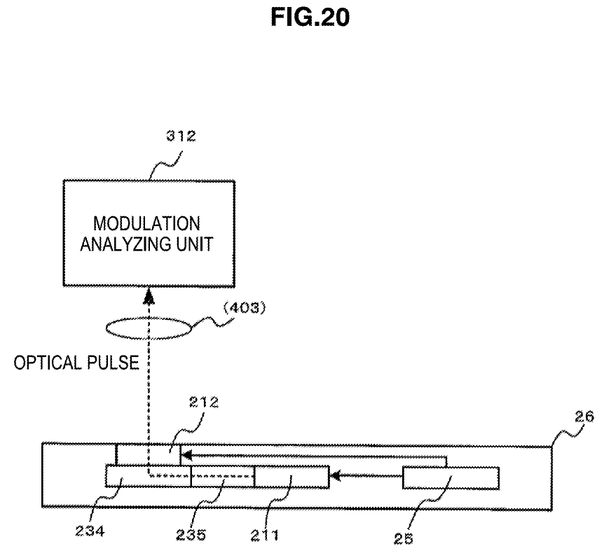

FIG. 20 illustrates a second structure example of the terminal device according to the second embodiment. The modulation analyzing unit 312 of the terminal device 31 is arranged to face the surface of the IC card 21, and receives the optical pulse output from the modulating unit 212 of the IC card 21. Further, the optical pulse output, for example, from the surface of the IC card 21 may be supplied to the modulation analyzing unit 312 using a lens 403.

By configuring the IC card 21 and the terminal device 31 as described above, similarly to the first structure example, the optical pulse output from the light source unit 211 of the IC card 21 is modulated by the modulating unit 212 and then supplied to the terminal device 31. Further, the terminal device 31 analyzes the modulation state of the modulated optical pulse through the modulation analyzing unit 312 and can perform the quantum cryptography communication. Further, since the quantum cryptography communication can be performed, the common key can be safely generated and used, and thus communication used for the common key cryptosystem can be safely performed.

### 3-3. Third Structure Example of IC Card and Terminal Device According to Second Embodiment

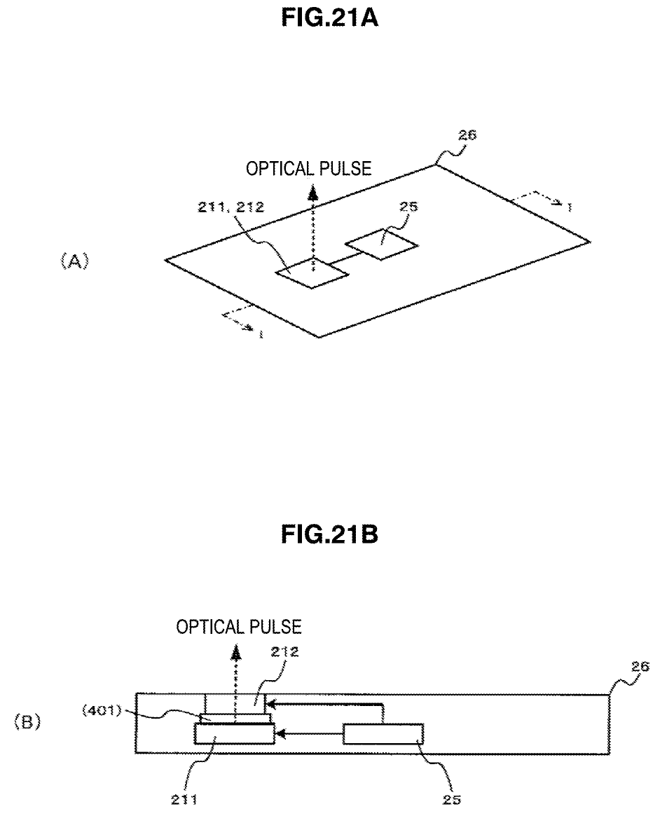

FIGS. 21A and 21B illustrate a third structure example of an IC card according to the second embodiment. FIG. 21A is a perspective view of an IC card, and FIG. 21B is a schematic cross-sectional view taken along line I-I in the IC card of FIG. 21A.

The IC card 21 is configured such that the substrate 25 provided with a memory unit and the like is interposed between outer sheets 26. The light source unit 211 and the modulating unit 212 are stacked and arranged in the IC card 21.

The light source unit 211 is configured with a surface-emitting type light-emitting element such as a surface-emitting laser or a surface-emitting LED. The modulating unit 212 modulates an optical pulse output from the light source unit 211, and outputs the modulated optical pulse, for example, in a direction vertical to the surface of the IC card 21. Further, a polarizer 401 may be arranged between the light source unit 211 and the modulating unit 212, and so the polarization direction and the optical axis of the modulating unit 212 can be set at a desired angle.

A third structure of the terminal device 31 according to the second embodiment is the same as the second structure illustrated in FIG. 20. The modulation analyzing unit 312 of the terminal device 31 is arranged to face the surface of the IC card 21 and receives the optical pulse output from the modulating unit 212 of the IC card 21.

By configuring the IC card 21 and the terminal device 31 as described above, similarly to the first and second structure examples, the optical pulse output from the light source unit 211 of the IC card 21 is modulated by the modulating unit 212 and then supplied to the terminal device 31. Further, the terminal device 31 analyzes the modulation state of the modulated optical pulse through the modulation analyzing unit 312 and can perform the quantum cryptography communication. Further, since the quantum cryptography communication can be performed, the common key can be safely generated and used, and thus communication used for the common key cryptosystem can be safely performed.

The above embodiments have been described in connection with the example in which the light source unit is arranged in the terminal device and the example in which the light source unit is arranged in the IC card. However, it should be noted that the present technology is not interpreted to be limited to the above embodiments. It should be understood by those skilled in the art that various modifications, combinations, sub-combinations and alterations may occur depending on design requirements and other factors insofar as they are within the scope of the appended claims or the equivalents thereof.

Additionally, the present technology may also be configured as below.
(1)

An IC card, including:

a modulating unit that modulates an optical pulse and outputs the modulated optical pulse to a quantum communication path;

a communication unit that performs classical communication via a classical communication path; and

a control unit that changes a modulation state of the optical pulse, performs quantum communication, and generates a common key based on the classical communication of information according to a communication result of the quantum communication.
(2)

The IC card according to (1),

wherein the modulating unit modulates the optical pulse output from a terminal device.
(3)

The IC card according to (2),

wherein the modulating unit modulates an optical pulse input from one surface of a card and outputs the modulated optical pulse from the other surface.
(4)

The IC card according to (2), further including:

a reflecting unit that reflects the optical pulse,

wherein an optical pulse output from the modulating unit is reflected and returned to the modulating unit, and

the modulating unit modulates an optical pulse input from one surface of a card and outputs the modulated optical pulse from the one surface.
(5)

The IC card according to (2), further including:

a first waveguide that causes an optical pulse to be input from a card end portion to the modulating unit; and

a second waveguide that causes an optical pulse modulated by the modulating unit to be output from the card end portion.
(6)

The IC card according to (2), further including

an optical path converting unit that bends an optical path of an optical pulse input from one surface of a card and causes the optical pulse to be output from a card end portion via a waveguide,

wherein the modulating unit is arranged in the middle of the optical path of the optical pulse.
(7)

The IC card according to (1), further including:

a light source unit that generates an optical pulse,

wherein the modulating unit modulates the optical pulse generated by the light source unit.
(8)

The IC card according to (7), further including:

a first waveguide that causes an optical pulse to be input from the light source unit to the modulating unit; and

a second waveguide that causes an optical pulse modulated by the modulating unit to be output from a card end portion.
(9)

The IC card according to (7), further including:

an optical path converting unit that bends an optical path of an optical pulse supplied from the light source unit via a waveguide formed in a card surface direction and causes the optical pulse to be output from one surface of the card,

wherein the modulating unit is arranged in the middle of the optical path of the optical pulse.
(10)

The IC card according to (7),

wherein the light source unit and the modulating unit are stacked, and

the optical pulse generated by the light source unit is modulated by the modulating unit and then output from one surface of a card.
(11)

The IC card according to any one of (1) to (10),

wherein the modulating unit performs polarization modulation or phase modulation of the optical pulse.

In an IC card according to the present technology, an IC card is provided with a modulating unit that modulates an optical pulse and outputs a modulated optical pulse and a control unit that randomly changes a modulation state of an optical pulse to any one of a plurality of previously set modulation states. The IC card can perform quantum cryptography communication a terminal device. Thus, since a common key can be simply and safely generated at a low cost through quantum cryptography communication, security can be increased in various systems using an IC card.

The present technology contains subject matter related to that disclosed in Japanese Priority Patent Application JP 2011-092577 filed in the Japan Patent Office on Apr. 19, 2011, the entire content of which is hereby incorporated by reference.

What is claimed is:

1. An IC card, comprising:
a modulating unit that modulates an optical pulse and outputs the modulated optical pulse to a quantum communication path;
a communication unit that performs classical communication via a classical communication path; and
a control unit that changes a modulation state of the optical pulse, performs quantum communication, and generates a common key based on the classical communication of information according to a communication result of the quantum communication.

2. The IC card according to claim 1,
wherein the modulating unit modulates the optical pulse output from a terminal device.

3. The IC card according to claim 2,
wherein the modulating unit modulates an optical pulse input from one surface of a card and outputs the modulated optical pulse from the other surface.

4. The IC card according to claim 2, further comprising:
a reflecting unit that reflects the optical pulse,
wherein an optical pulse output from the modulating unit is reflected and returned to the modulating unit, and
the modulating unit modulates an optical pulse input from one surface of a card and outputs the modulated optical pulse from the one surface.

5. The IC card according to claim 2, further comprising:
a first waveguide that causes an optical pulse to be input from a card end portion to the modulating unit; and
a second waveguide that causes an optical pulse modulated by the modulating unit to be output from the card end portion.

6. The IC card according to claim 2, further comprising
an optical path converting unit that bends an optical path of an optical pulse input from one surface of a card and causes the optical pulse to be output from a card end portion via a waveguide,
wherein the modulating unit is arranged in the middle of the optical path of the optical pulse.

7. The IC card according to claim 1, further comprising:
a light source unit that generates an optical pulse,
wherein the modulating unit modulates the optical pulse generated by the light source unit.

8. The IC card according to claim 7, further comprising:
a first waveguide that causes an optical pulse to be input from the light source unit to the modulating unit; and
a second waveguide that causes an optical pulse modulated by the modulating unit to be output from a card end portion.

9. The IC card according to claim 7, further comprising:
an optical path converting unit that bends an optical path of an optical pulse supplied from the light source unit via a waveguide formed in a card surface direction and causes the optical pulse to be output from one surface of the card,
wherein the modulating unit is arranged in the middle of the optical path of the optical pulse.

10. The IC card according to claim 7,
wherein the light source unit and the modulating unit are stacked, and
the optical pulse generated by the light source unit is modulated by the modulating unit and then output from one surface of a card.

11. The IC card according to claim 1,
wherein the modulating unit performs polarization modulation or phase modulation of the optical pulse.
